(19) United States
(12) Patent Application Publication
(10) Pub. No.: US 2015/0356684 A1
(43) Pub. Date: Dec. 10, 2015

(54) Financial Portfolio Analysis Systems and Methods

(71) Applicants: Alfred Owen Taylor, JR., Columbus, IN (US); Bernard Koczaja, Franklin, TN (US)

(72) Inventors: Alfred Owen Taylor, JR., Columbus, IN (US); Bernard Koczaja, Franklin, TN (US)

(21) Appl. No.: 14/731,522

(22) Filed: Jun. 5, 2015

Related U.S. Application Data
(60) Provisional application No. 62/008,378, filed on Jun. 5, 2014.

(51) Int. Cl. G06Q 40/06

(52) U.S. Cl. CPC G06Q 40/06

(57) ABSTRACT

Provided are systems and methods relating to financial portfolio analysis, including a computer processing structure configured to compare an investment to a metric that may be selected from a list or may be specially constructed as a hybrid, weighted metric from a plurality of indexes and other sub-metrics. The computer processing structure is specially adapted to apply SPC-like statistical analysis to one or more investments in view of the selected metric, and to optionally provide alerts when statistically significant events occur. The computer processing structure may also be specially adapted to output a variety of reports that may be color coded to indicate degree of compliance with predetermined criteria and to highlight issues and raise questions.

### CROSS-REFERENCE TO RELATED APPLICATIONS

This application claims priority to, incorporates by reference, and is a non-provisional of U.S. patent application Ser. No. 62/008,378, filed Jun. 5, 2014.

### FEDERALLY SPONSORED RESEARCH OR DEVELOPMENT

None.

### TECHNICAL FIELD

The present invention relates generally to computer-implemented systems and methods relating to financial portfolio analysis.

### BACKGROUND

According to the Investment Company Institute, investors that are saving for retirement, planning to retire, or already retired have amassed $5.9 trillion in 401(k) and other defined contribution plans, plus another $6.6 trillion in individual retirement accounts, or IRA's. These savers are concerned about the amount they have saved for retirement and the performance of their investments.

In order to evaluate the performance of their investments, the wealthiest investors often use personal financial advisors to perform independent assessments. But many investors forego the process of finding and hiring a personal financial advisor, and instead pay a fee (often one to two percent annually of the invested value) to an investment firm or fund that suggests or selects assets and their allocations, and then provides tools to assess their performance. But having the same entity assess the performance of the choices that they made or suggested can create a perceived or actual conflict of interest, which leaves investors questioning whether their investment allocations are really performing as well as they should. Many investors are also unsure what questions they should ask their investment firm or advisor to help evaluate their situation.

### SUMMARY

The present invention elegantly addresses the above challenges and provides numerous additional benefits as will be apparent to persons of skill in the art. Provided in various example embodiments is a method of analyzing the performance of an investment by utilizing computer processing structure, the method comprising the steps of: determining with the computer processing structure a periodic series of percentage changes of a metric over a period of time; determining with the computer processing structure a rolling average of the percentage changes of the metric over a period of time; determining with the computer processing structure a rolling upper control limit that is greater in value than the rolling average of the metric by a multiple of a standard deviation of the periodic series of percentage changes of the metric over the period of time; determining with the computer processing structure a rolling lower control limit that is lesser in value than the rolling average of the metric by a multiple of a standard deviation of the periodic series of percentage changes of the metric over the period of time; determining with the computer processing structure a periodic series of percentage changes of an investment over the period of time; and outputting from the computer processing structure a visual representation of the periodic series of percentage changes of the investment over the period of time, overlaid with a visual representation of the rolling average of the percentage changes of the metric over the period of time and a visual representation of the rolling upper control limit over the period of time and a visual representation of the rolling lower control limit over the period of time. In various example embodiments the method may further comprise selecting with the computer processing structure the metric from a list of predetermined metrics. In various example embodiments the method may further comprise generating with the computer processing structure the metric by entering a plurality of sub-metrics and allocating a percentage weight to each sub-metric. In various example embodiments the method may further comprise determining with the computer processing structure whether the periodic series of percentage changes of the investment over the period of time exceeds the rolling upper control limit or the rolling lower control limit over the period of time. In various example embodiments the method may further comprise generating with the computer processing structure and electronically communicating an alert when the periodic series of percentage changes of the investment over the period of time exceeds the rolling upper control limit or the rolling lower control limit over the period of time. In various example embodiments the method may further comprise changing the investment or the metric with the computer processing structure based on information communicated in the alert. In various example embodiments the method may further comprise determining with the computer processing structure whether the periodic series of percentage changes of the investment remains above or below the rolling average of the percentage changes of the metric for a predetermined period of time. In various example embodiments the method may further comprise generating with the computer processing structure and electronically communicating an alert when the periodic series of percentage changes of the investment remains above or below the rolling average of the percentage changes of the metric for a predetermined period of time. In various example embodiments the method may further comprise selecting with the computer processing structure a different investment based on the visual representation. In various example embodiments the method may further comprise selecting with the computer processing structure a different metric based on the visual representation.

Also provided in various example embodiments is a computer processing structure for analyzing the performance of an investment, the computer processing structure comprising: means for determining a periodic series of percentage changes of a metric over a period of time; means for determining a rolling average of the percentage changes of the metric over a period of time; means for determining a rolling upper control limit that is greater in value than the rolling average of the metric by a multiple of a standard deviation of the periodic series of percentage changes of the metric over the period of time; means for determining a rolling lower control limit that is lesser in value than the rolling average of the metric by a multiple of a standard deviation of the periodic series of percentage changes of the metric over the period of time; means for determining a periodic series of percentage changes of an investment over the period of time; and means for outputting a visual representation of the periodic series of percentage changes of the investment over the period of time, overlaid with a visual representation of the rolling average of the percentage changes of the metric over the period of time and a visual representation of the rolling upper control limit over the period of time and a visual representation of the rolling lower control limit over the period of time. In various example embodiments the computer processing structure may further comprise means for selecting the metric from a list of predetermined metrics. In various example embodiments the computer processing structure may further comprise means for generating the metric by entering a plurality of sub-metrics and allocating a percentage weight to each sub-metric. In various example embodiments the computer processing structure may further comprise means for determining whether the periodic series of percentage changes of the investment over the period of time exceeds the rolling upper control limit or the rolling lower control limit over the period of time. In various example embodiments the computer processing structure may further comprise means for generating and electronically communicating an alert when the periodic series of percentage changes of the investment over the period of time exceeds the rolling upper control limit or the rolling lower control limit over the period of time. In various example embodiments the computer processing structure may further comprise means for changing the investment or the metric based on information communicated in the alert. In various example embodiments the computer processing structure may further comprise means for determining whether the periodic series of percentage changes of the investment remains above or below the rolling average of the percentage changes of the metric for a predetermined period of time. In various example embodiments the computer processing structure may further comprise means for generating and electronically communicating an alert when the periodic series of percentage changes of the investment remains above or below the rolling average of the percentage changes of the metric for a predetermined period of time. In various example embodiments the computer processing structure may further comprise means for selecting a different investment based on the visual representation. In various example embodiments the computer processing structure may further comprise means for selecting a different metric based on the visual representation.

Additional aspects, alternatives and variations as would be apparent to persons of skill in the art are also disclosed herein and are specifically contemplated as included as part of the invention. The invention is defined only by the claims as allowed by the patent office in this or related applications, and the following figures and descriptions of certain examples are not in any way to limit, define or otherwise establish the scope of legal protection.

### BRIEF DESCRIPTION OF THE DRAWINGS

The accompanying figures illustrate certain aspects of example embodiments of the invention, wherein:

FIG. 1 is a flowchart depicting example processes and steps operable in a computer processing structure for financial portfolio analysis, according to various example embodiments.

FIG. 2 is a flowchart depicting example processes and steps operable in a computer processing structure for selecting or generating a metric, according to various example embodiments.

FIG. 3 is a chart visually depicting the daily price performance of a stock (in this case HOG), over a given period of time, in comparison to 4 and 8 percent growth rate targets, as communicated, printed, displayed, or otherwise outputted by a computer processing structure according to various example embodiments.

FIG. 4 is a chart visually depicting the daily price performance of a Market Index Fund (in this case VTSMX), over the same period of time as used in FIG. 3, in comparison to 4 and 8 percent growth rate targets, as communicated, printed, displayed, or otherwise outputted by a computer processing structure according to various example embodiments.

FIG. 5 is a chart visually depicting the daily percentage change in value of the S&P 500 index (“S&P”), over the same period of time as used in FIG. 3, further depicting overlays of the rolling average of this data and a rolling Upper Control Limit line that is three standard deviations above the rolling average, and a rolling Lower Control Limit line that is three standard deviations below the rolling average, as communicated, printed, displayed, or otherwise outputted by a computer processing structure according to various example embodiments.

FIG. 6 is a chart visually depicting the daily percentage change in price of a stock (in this case HOG), over the same period of time as used in FIG. 3, overlaid over the data illustrated in FIG. 5, as communicated, printed, displayed, or otherwise outputted by a computer processing structure according to various example embodiments.

FIG. 7 is a chart visually depicting the daily percentage change in price of a Market Index Fund (in this case VTSMX), over the same period of time as used in FIG. 3, overlaid over the data illustrated in FIG. 5, as communicated, printed, displayed, or otherwise outputted by a computer processing structure according to various example embodiments.

FIG. 8 is a chart visually depicting the daily percentage change in value of an exchange traded fund (in this case ProShares UltraPro Financials ETF FINU), over the same period of time as used in FIG. 3, further depicting overlays of the rolling average of this data and a rolling Upper Control Limit line that is three standard deviations above the rolling average, and a rolling Lower Control Limit line that is three standard deviations below the rolling average, as communicated, printed, displayed, or otherwise outputted by a computer processing structure according to various example embodiments.

FIG. 9 is a chart visually depicting the daily percentage change in price of a stock (in this case HOG), over the same period of time as used in FIG. 3, overlaid over the data illustrated in FIG. 8, as communicated, printed, displayed, or otherwise outputted by a computer processing structure according to various example embodiments.

FIG. 10 is a chart visually depicting the daily percentage change in price of a Market Index Fund (in this case VTSMX), over the same period of time as used in FIG. 3, overlaid over the data illustrated in FIG. 8, as communicated, printed, displayed, or otherwise outputted by a computer processing structure according to various example embodiments.

FIG. 11A is an example matrix as communicated, printed, displayed, or otherwise outputted by a computer processing structure according to various example embodiments, for visually communicating the performance of various investment performance criteria.

FIG. 11B is an example color key for interpreting the example matrix of FIG. 11A, as communicated, printed, displayed, or otherwise outputted by a computer processing structure according to various example embodiments, for visually communicating the overall performance of an investment based on various underlying investment performance criteria.

FIG. 12 is an example asset allocation report as communicated, printed, displayed, or otherwise outputted by a computer processing structure according to various example embodiments, for visually communicating the relative allocations of assets in a portfolio over time, and visually flagging where allocations have exceeded predetermined limits.

FIG. 13 is non-limiting diagram of various example components of a computer processing structure according to various example embodiments.

### DETAILED DESCRIPTION OF EXAMPLE EMBODIMENTS

Reference is made herein to some specific examples of the present invention, including any best modes contemplated by the inventor for carrying out the invention. Examples of these specific embodiments are illustrated in the accompanying figures. While the invention is described in conjunction with these specific embodiments, it will be understood that it is not intended to limit the invention to the described or illustrated embodiments. To the contrary, it is intended to cover alternatives, modifications, and equivalents as may be included within the spirit and scope of the invention as defined by the claims that will be appended in any subsequent regular utility patent application claiming priority to this provisional application.

In the following description, numerous specific details are set forth in order to provide a thorough understanding of the present invention. Particular example embodiments of the present invention may be implemented without some or all of these features or specific details. In other instances, components and process operations well known to persons of skill in the art have not been described in detail in order not to obscure unnecessarily the present invention.

Various techniques and mechanisms of the present invention will sometimes be described in singular form for clarity. However, it should be noted that some embodiments may include multiple iterations of a technique or multiple components, mechanisms, and the like, unless noted otherwise. Similarly, various steps of the methods shown and described herein are not necessarily performed in the order indicated, or performed at all in certain embodiments. Accordingly, some implementations of the methods discussed herein may include more or fewer steps than those shown or described.

Further, the techniques and mechanisms of the present invention will sometimes describe a connection, relationship or communication between two or more items or entities. It should be noted that a connection or relationship between entities does not necessarily mean a direct, unimpeded connection, as a variety of other entities or processes may reside or occur between any two entities. Consequently, an indicated connection does not necessarily mean a direct, unimpeded connection unless otherwise noted.

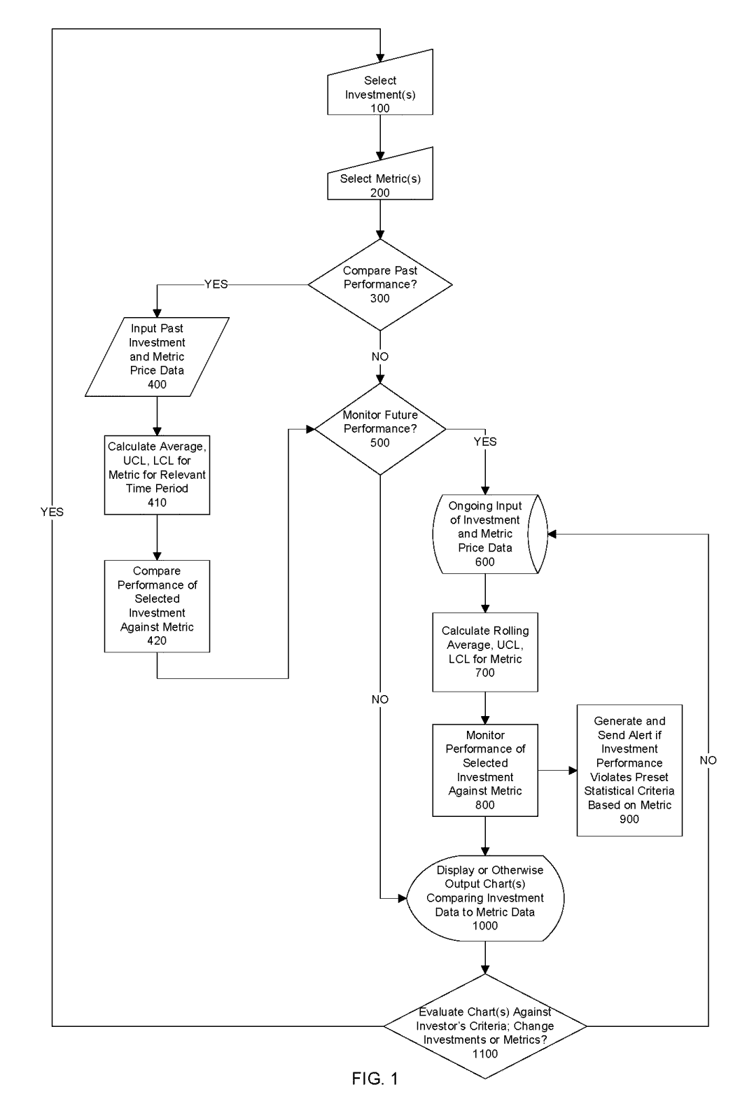

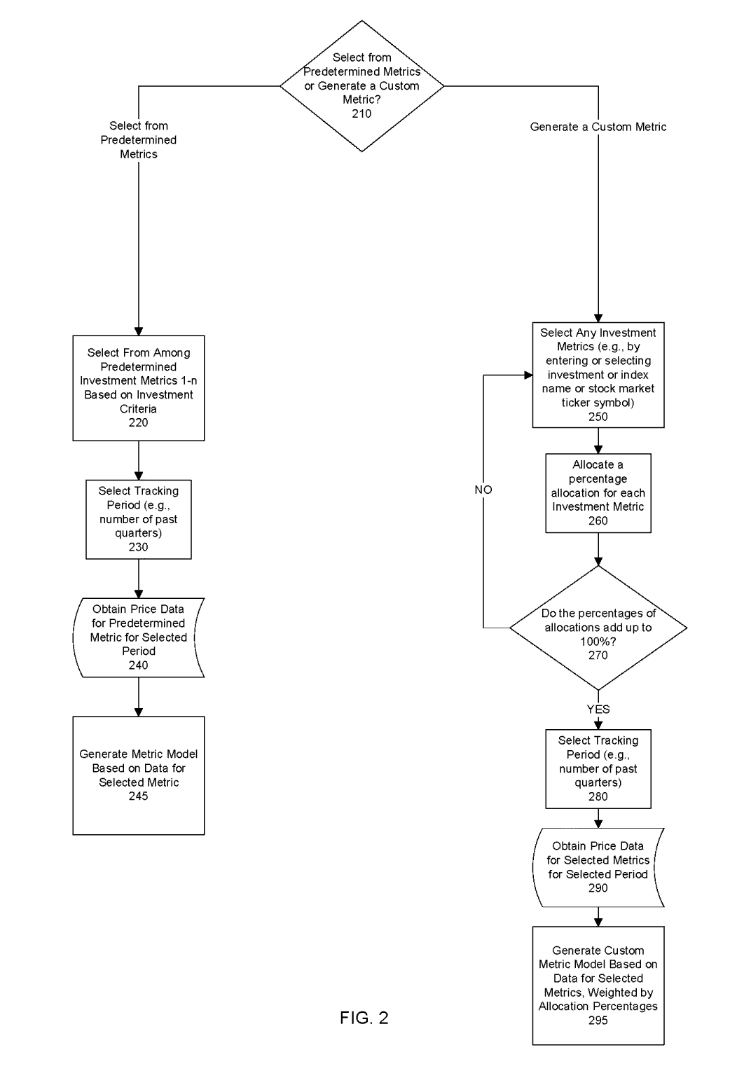

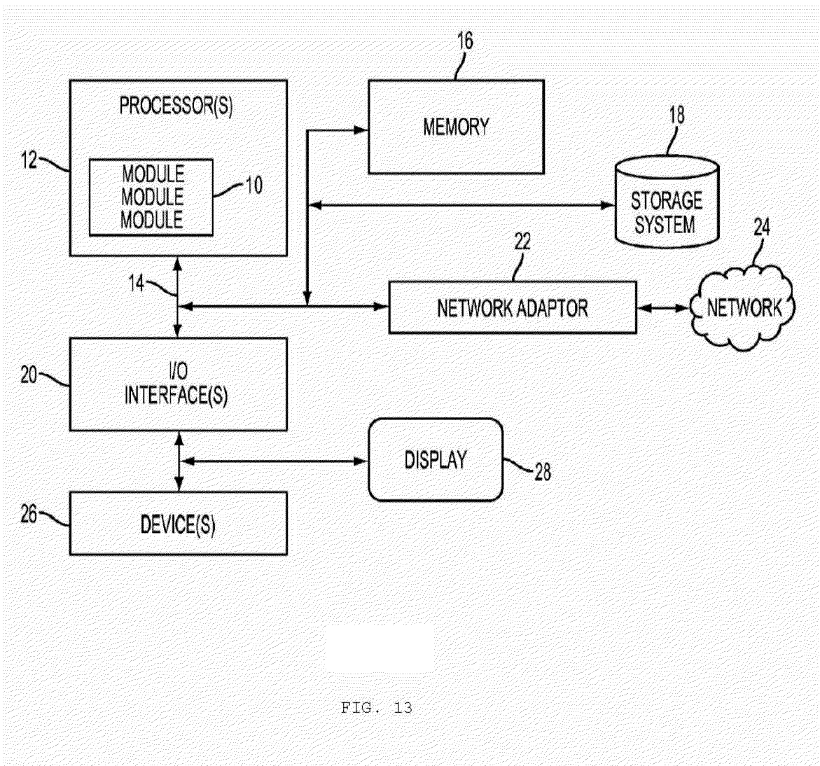

Provided in various example embodiments is a computer processing structure (see FIG. 13) and method (see FIGS. 1 and 2) operable on a computer processing structure that employs statistical methodology to help investors evaluate the performance of an investment by comparing its performance to a statistical range generated from data driven by a selectable or customizable metric. In various example embodiments, the statistical methodology may be analogous to the statistical process control (SPC) techniques used in manufacturing to control dimensional and other variations by alerting when a process either exceeds control limits or is trending away from a nominal baseline for a statistically significant period. But unlike traditional SPC methodology used in manufacturing, here the baseline is typically not a fixed number but rather a varying metric such as an index. An example of calculating rolling averages and upper and lower control limits based on a multiple of standard deviations from the average (of raw price data of once investment) is discussed in U.S. Pat. No. 7,299,205 B2 issued Nov. 20, 2007 to Weinberger (herein “Weinberger”), the entirety of which is incorporated herein by reference. While Weinberger discusses applying an SPC-like analysis to the raw price data of a particular investment such as a stock, Weinberger is directed to a different purpose and neither teaches nor suggests, among other things, the present system and method of using SPC-like analyses to track an investment against the rolling average and upper and lower control limits of a different metric.

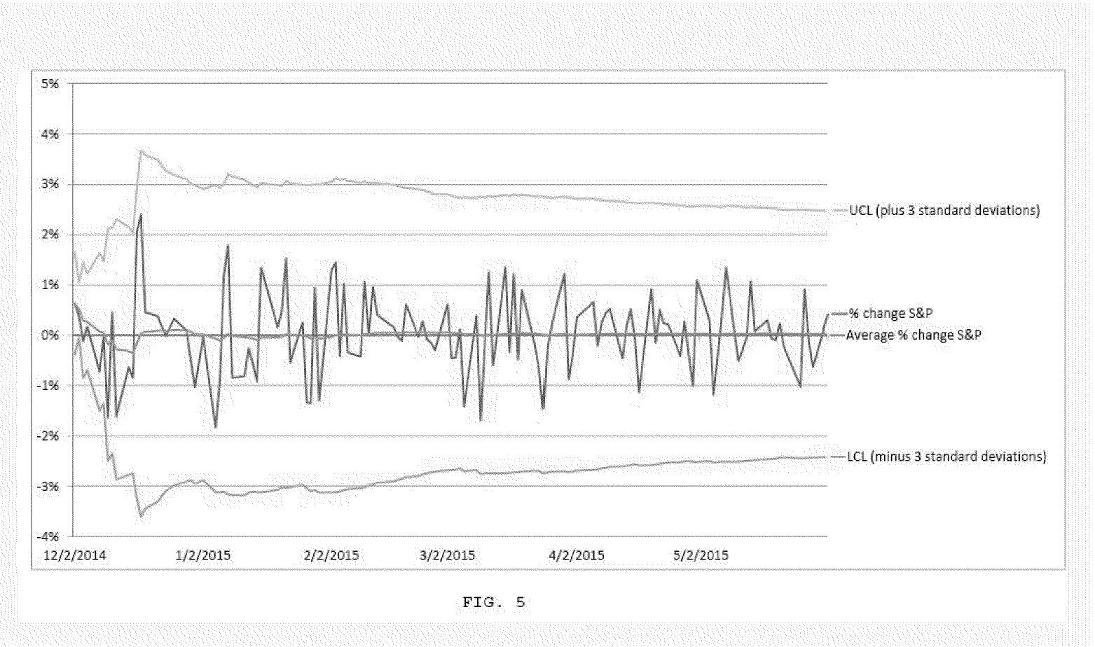

The method may comprise the step of determining with the computer processing structure a periodic series of percentage changes of a metric over a period of time, and determining with the computer processing structure a rolling average of the percentage changes of the metric over a period of time. The method may comprise the step of determining with the computer processing structure a rolling upper control limit that is greater in value than the rolling average of the metric by a multiple of a standard deviation of the periodic series of percentage changes of the metric over the period of time, and determining with the computer processing structure a rolling lower control limit that is lesser in value than the rolling average of the metric by a multiple of a standard deviation of the periodic series of percentage changes of the metric over the period of time. For example, the multiple of standard deviations may be 1, 2, 3, or 4, for example. The multiple need not be a whole number, and can be any suitable number. The method may further comprise determining with the computer processing structure a periodic series of percentage changes of an investment over the period of time, and outputting from the computer processing structure a visual representation of the periodic series of percentage changes of the investment over the period of time, overlaid with a visual representation of the rolling average of the percentage changes of the metric over the period of time and a visual representation of the rolling upper control limit over the period of time and a visual representation of the rolling lower control limit over the period of time, for instance as shown in FIGS. 5 through 10.

With respect to FIG. 1, provided in various example embodiments is a method of analyzing the performance of an investment by utilizing computer processing structure (an example of which is shown in FIG. 13 and discussed herein). At step 100 a user may select or input an investment for which price or value data is available. At step 200 a user may select a metric for which price or value data is available, for instance as shown in FIG. 2 and described further herein. In various example embodiments, at step 300 a user may elect to compare past performance of the investment to the past performance of the metric. Where the user elects to compare past performance of the investment to the past performance of the metric, at step 400 the computer processing structure inputs past price or value data, for instance from local databases or from external electronically connected sources such as websites or databases on the Internet or other network. Once the price or value data is collected for a relevant time period, which may be user-selected, at step 410 the computer processing structure may calculate the daily or other time-based percentage changes in the prices or values, and the rolling average, rolling upper control limit, and rolling lower control limit for the percentage changes in the metric, for instance as discussed with respect to the raw price data (and not percentage change data) of a particular investment (and not a metric) in Weinberger, all of which is incorporated herein by reference. Once the calculations are performed at step 410, the processed data for the investment and metric is compared at step 420. In various example embodiments the user may then be prompted to determine whether to monitor the future performance of the investment relative to the metric at step 500. Also once the processed data for the investment and metric is compared at step 420, at step 1000 the computer processing structure may then communicate, print, display, or otherwise output one or more charts (for instance for different time periods) comparing the performance of the investment to the rolling average and upper and lower control limits of the metric, for instance as shown in FIGS. 5-10.

With continuing reference to FIG. 1, regardless whether the user elects at step 300 to review past data, in various example embodiments the user may elect at step 500 to monitor future performance. Where the user elects to monitor future performance of the investment relative to the metric, at step 600 the computer processing structure periodically or continuously inputs new or recent price or value data, for instance from local databases or from external electronically connected sources such as websites or databases on the Internet or other network. As the price or value data is collected, at step 700 the computer processing structure may calculate the daily or other time-based percentage changes in the prices or values, and the rolling average, rolling upper control limit, and rolling lower control limit for the percentage changes in the metric, for instance as discussed with respect to the raw price data (and not percentage change data) of a particular investment (and not a metric) in Weinberger, all of which is incorporated herein by reference. As the calculations are performed at step 700, the processed data for the investment and metric is periodically or continuously compared at step 800. If the comparison at step 800 indicates that the performance of the investment relative to the metric has violated a preset or predetermined statistical criteria, then the computer processing structure may at step 900 issue an alert to be communicated to the user or an advisor or other appropriate person. The alert may be communicated electronically, including audibly, printed, displayed, or otherwise output. Non-limiting examples of preset or predetermined statistical criteria that might trigger unique and increasingly urgent alerts 900 may include: a negative three or more quarter trend (slope) that remains within control limits; a negative three or more quarter trend that is below the mean (or rolling average), but within control limits; and any point below the lower control limit. A point above the upper control limit may warrant an alert as well, since the investor might use that as an indication to sell a volatile investment. As the processed data for the investment and metric is compared at step 800, at step 1000 the computer processing structure may periodically or upon command communicate, print, display, or otherwise output one or more charts (for instance for different time periods) comparing the performance of the investment to the rolling average and upper and lower control limits of the metric, for instance as shown in FIGS. 5-10. Finally at step 1100 the user may evaluate the charts (see, e.g., FIGS. 5-10) against the investor's criteria, and decide whether to change investments or metrics or both, in which case the process repeats by returning to step 100 as shown in FIG. 1.

As illustrated in FIG. 2, in various example embodiments the user may decide at step 210 whether to select the varying metric or index that is different from the investment from a list of predetermined choices or whether to custom-develop the metric. If the user elects to select the metric from a list of predetermined choices, in various example embodiments the user at step 220 may utilize the computer processing structure to select from among predetermined investment metrics 1-n, where n can be any suitable number. Whether the metric is selected from a predetermined list or custom-designed, it should be appropriate for the investor's investment profile and investing style, such as conservative or aggressive, bullish or bearish, preservation or growth, etc. Also, in various example embodiments a plurality of such metrics may be applied simultaneously or alternatively. Then at step 230 the user can utilize the computer processing structure to select one or more desired tracking periods, and one or more frequencies for obtaining data (e.g., daily, weekly, etc.). At step 240 the computer processing structure inputs past price or value data, for instance from local databases or from external electronically connected sources such as websites or databases on the Internet or other network. Once the price or value data is collected for a relevant time period, which may be user-selected, at step 245 the computer processing structure may generate the mathematical model for the metric, for instance by calculating the daily or other time-based percentage changes in its prices or values, and the rolling average, rolling upper control limit, and rolling lower control limit for the percentage changes in the metric, for instance as discussed with respect to the raw price data (and not percentage change data) of a particular investment (and not a metric) in Weinberger, all of which is incorporated herein by reference. Once the calculations are performed at step 245, the metric is ready for use by the computer processing structure in comparing against investments selected by the user. The investor's investments can then be tracked against one or more of these metrics and statistically evaluated retrospectively, or prospectively in an ongoing manner, or both, to evaluate and track the performance of the chosen investments against the metrics that were selected, as illustrated in FIG. 1, using example outputs as illustrated in FIGS. 5-10.

With continuing reference to FIG. 2, in various example embodiments the computer processing structure may be used to generate a custom metric. For instance at step 250, a user may utilize the computer processing structure to select any investment metrics for which data is available (e.g., by entering or selecting an investment or index name or stock market ticker symbol). In various example embodiments the user may utilize the computer processing structure to allocate a percentage allocation for each investment metric at step 260, for instance to weight them. By way of example and not limitation, a user could create a metric that is 50% weighted to a small cap index, and 50% to a large cap index, and the resulting hybrid or custom metric would be 50% influenced by the small cap index and 50% influenced by the large cap index. Thus, if on one day the small cap index was up 1% and the large cap index was down 1%, the above metric would be flat for the day, showing no change for that day. Each of a plurality of indexes, stocks, or other instruments or measurements that make up a given custom or hybrid metric may be referred to as a sub-metric. Any suitable number of sub-metrics may be used in constructing a metric under steps 250, 260, and 270. Step 270 ensures that the total allocations for a metric add up to 100%. Then at step 280 the user can utilize the computer processing structure to select one or more desired tracking periods, and one or more frequencies for obtaining data (e.g., daily, weekly, etc.). At step 290 the computer processing structure inputs past price or value data, for instance from local databases or from external electronically connected sources such as websites or databases on the Internet or other network. Once the price or value data is collected for a relevant time period, which may be user-selected, at step 295 the computer processing structure may generate the mathematical model for the metric, for instance by calculating the daily or other time-based percentage changes in its prices or values, and the rolling average, rolling upper control limit, and rolling lower control limit for the percentage changes in the metric, for instance as discussed with respect to the raw price data (and not percentage change data) of a particular investment (and not a metric) in Weinberger, all of which is incorporated herein by reference. Once the calculations are performed at step 295, the metric is ready for use by the computer processing structure in comparing against investments selected by the user. The investor's investments can then be tracked against one or more of these metrics and statistically evaluated retrospectively, or prospectively in an ongoing manner, or both, to evaluate and track the performance of the chosen investments against the metrics that were selected, as illustrated in FIG. 1, using example outputs as illustrated in FIGS. 5-10.

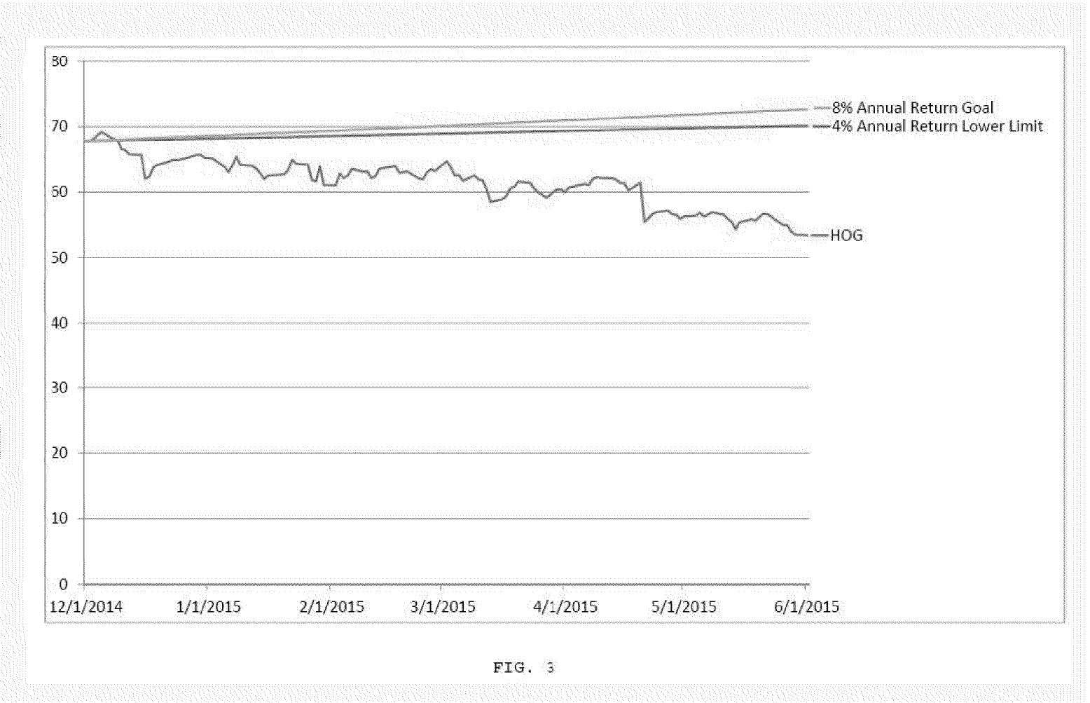

FIG. 3 depicts one example output of a computer processing structure according to various example embodiments, which may be part of a periodic performance report output by the computer processing structure, wherein the price of a first investment, in this case the stock with the ticker HOG, is tracked over time. As a first part of a performance report generated and output by the computer processing structure, the observation may be reported is that the investment has lost value over the selected time period, which may be represented in the report with a color such as red. As a second part of a performance report generated and output by the computer processing structure, it may be reported that the investment has failed to meet a predetermined goal performance threshold of 8% annual return rate, and has failed to meet a predetermined lower performance threshold of 4% annual return rate, which may also be represented in the report with a color such as red. In various example embodiments, a user may preselect and adjust those thresholds using the computer processing structure.

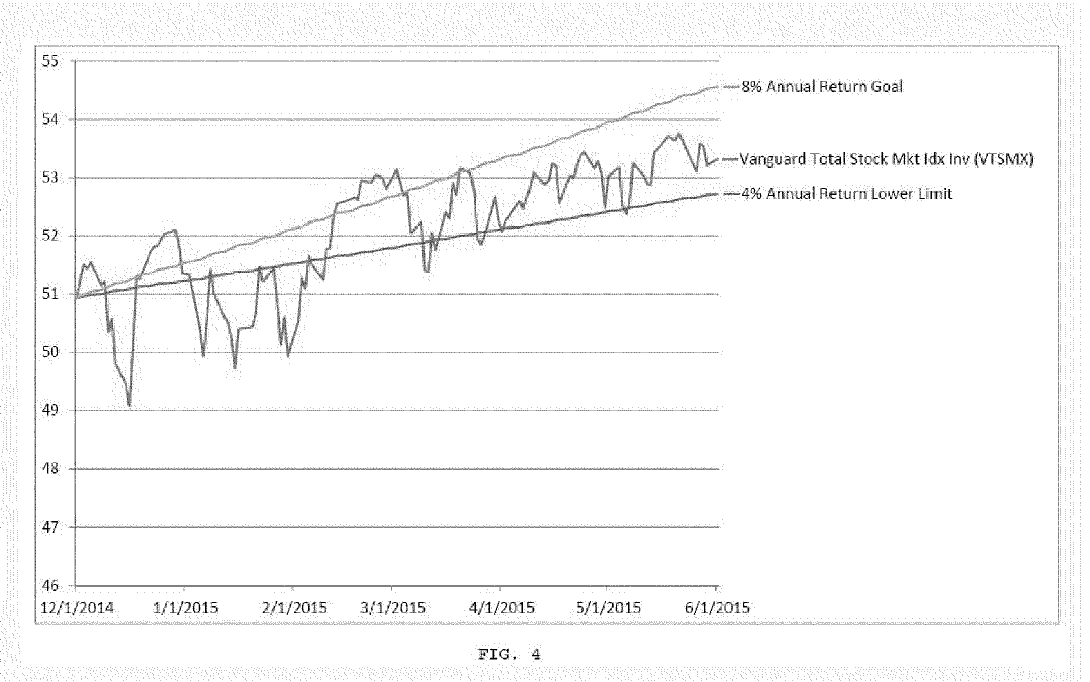

FIG. 4 depicts another example output of a computer processing structure according to various example embodiments, which may be part of a periodic performance report output by the computer processing structure, wherein the price of a second investment, in this case the fund with the ticker VTSMX, is tracked over time. As a first part of a performance report generated and output by the computer processing structure, the observation may be reported is that the investment has gained value over the selected time period, which may be represented in the report with a color such as green. As a second part of a performance report generated and output by the computer processing structure, it may be reported that the investment has only occasionally met a predetermined goal performance threshold of 8% annual return rate, but has recently regularly met a predetermined lower performance threshold of 4% annual return rate, which may also be represented in the report with a color such as green. In various example embodiments, a user may preselect and adjust those thresholds using the computer processing structure.

FIG. 5 is an example of a chart output by the computer processing structure that visually depicts the daily percentage change in value of a first example metric, in this case the S&P 500 index (“S&P”), over a period of time. FIG. 5 further depicts overlays of the rolling average of this data and a rolling Upper Control Limit line that is three standard deviations above the rolling average, and a rolling Lower Control Limit line that is three standard deviations below the rolling average, as communicated, printed, displayed, or otherwise outputted by a computer processing structure according to various example embodiments.

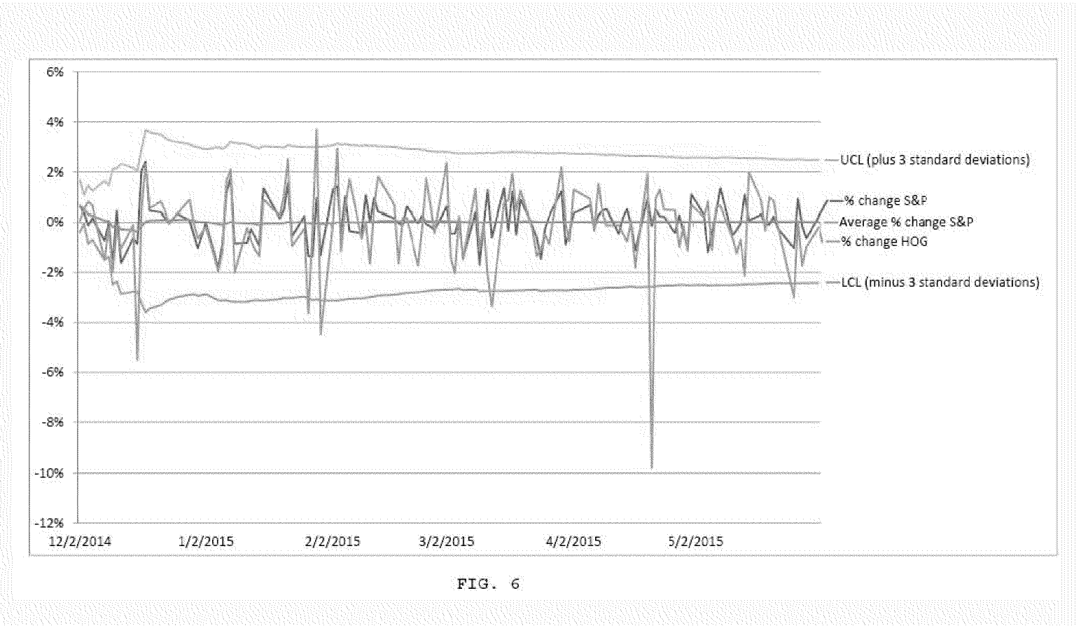

FIG. 6 is an example of a chart output by the computer processing structure that visually depicts the daily percentage change in price of the first example investment (HOG), over the same period of time as shown with respect to FIG. 3, overlaid over the data illustrated in FIG. 5, as communicated, printed, displayed, or otherwise outputted by a computer processing structure according to various example embodiments. It appears that, among other things, sometime in late April 2015 there was a strong downward percentage move in the price of HOG, which fell below the LCL. In the system depicted in FIG. 1, this event, along with earlier similar but less severe events, would likely have triggered an alert as discussed with respect to step 900. For example, if a user started using the system and method for HOG at the start of December, 2014, and had used the S&P 500 as the metric, then the user would soon have received an alert that the percentage price movement had exceeded the LCL of three standard deviations away from the rolling average of percentage moves in the S&P 500. If the user would have sold HOG upon receiving that alert, the user would have been spared the subsequent five additional downward moves below the LCL that occurred between that time and June, 2015.

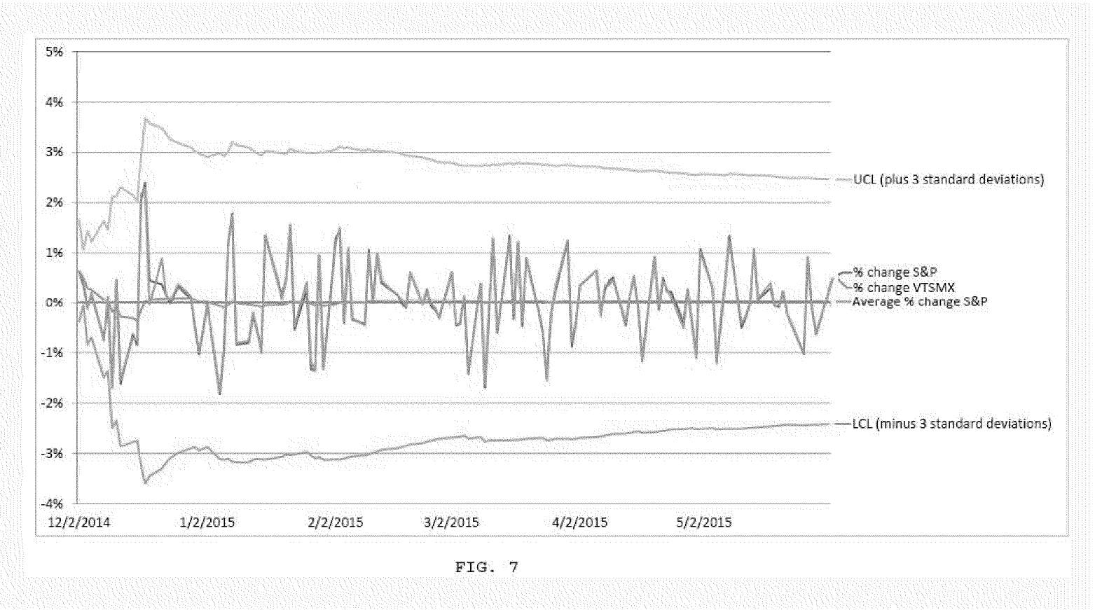

FIG. 7 is an example of a chart output by the computer processing structure that visually depicts the daily percentage change in price of the second example investment (VTSMX), over the same period of time as shown with respect to FIG. 3, overlaid over the data illustrated in FIG. 5, as communicated, printed, displayed, or otherwise outputted by a computer processing structure according to various example embodiments. It appears that VTSMX closely tracks the S&P 500, so there has been no violation of the LCL, nor would there likely be unless the broader market suddenly became more volatile, which would be an important reason for receiving an alert.

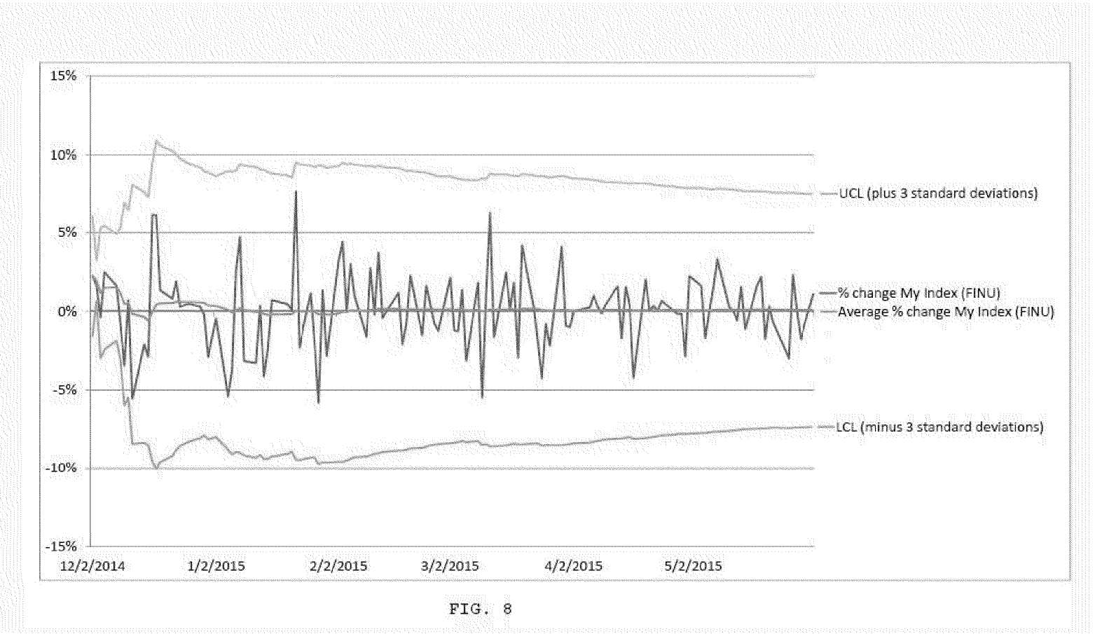

FIG. 8 is an example of a chart output by the computer processing structure that visually depicts the daily percentage change in value of a second example metric, in this case the exchange traded fund (in this case ProShares UltraPro Financials ETF FINU), over the same period of time used in the other examples. FIG. 8 further depicts overlays of the rolling average of this data and a rolling Upper Control Limit line that is three standard deviations above the rolling average, and a rolling Lower Control Limit line that is three standard deviations below the rolling average, as communicated, printed, displayed, or otherwise outputted by a computer processing structure according to various example embodiments.

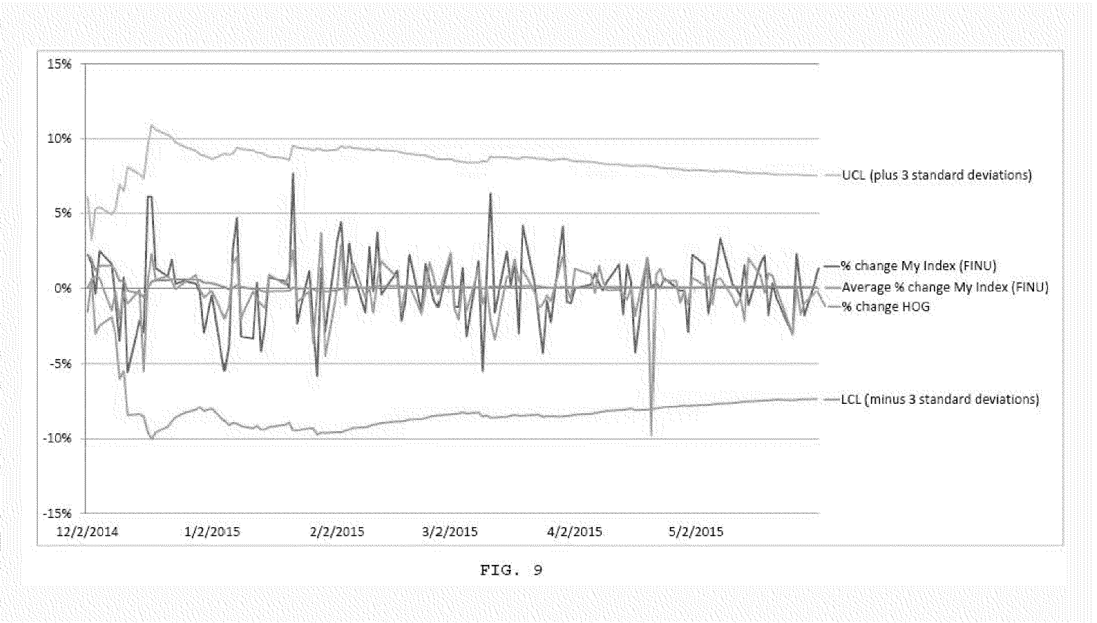

FIG. 9 is an example of a chart output by the computer processing structure that visually depicts the daily percentage change in price of the first example investment (HOG), over the same period of time as shown with respect to FIG. 3, overlaid over the data illustrated in FIG. 8, as communicated, printed, displayed, or otherwise outputted by a computer processing structure according to various example embodiments. It appears that by using this metric, there would not have been a below-LCL-alert until the recent large downturn. This is because the second metric, FINU, is much more volatile than the first metric, the S&P 500.

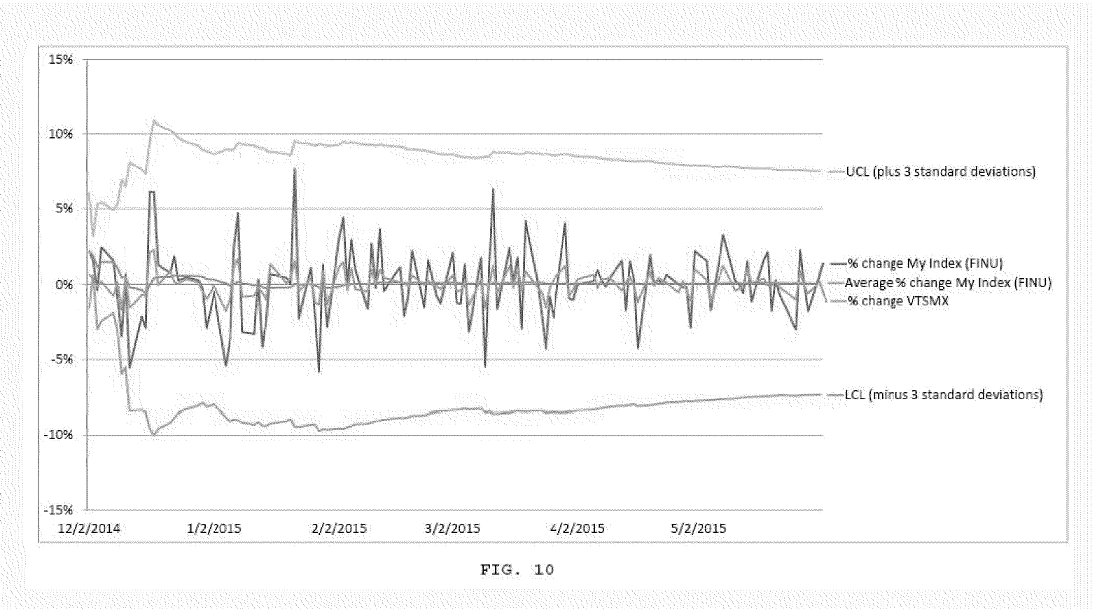

FIG. 10 is an example of a chart output by the computer processing structure that visually depicts the daily percentage change in price of the second example investment (VTSMX), over the same period of time as shown with respect to FIG. 3, overlaid over the data illustrated in FIG. 8, as communicated, printed, displayed, or otherwise outputted by a computer processing structure according to various example embodiments. It appears that VTSMX is much less volatile than the second metric, FINU, so there has been nothing close to a violation of the LCL during the reported time period.

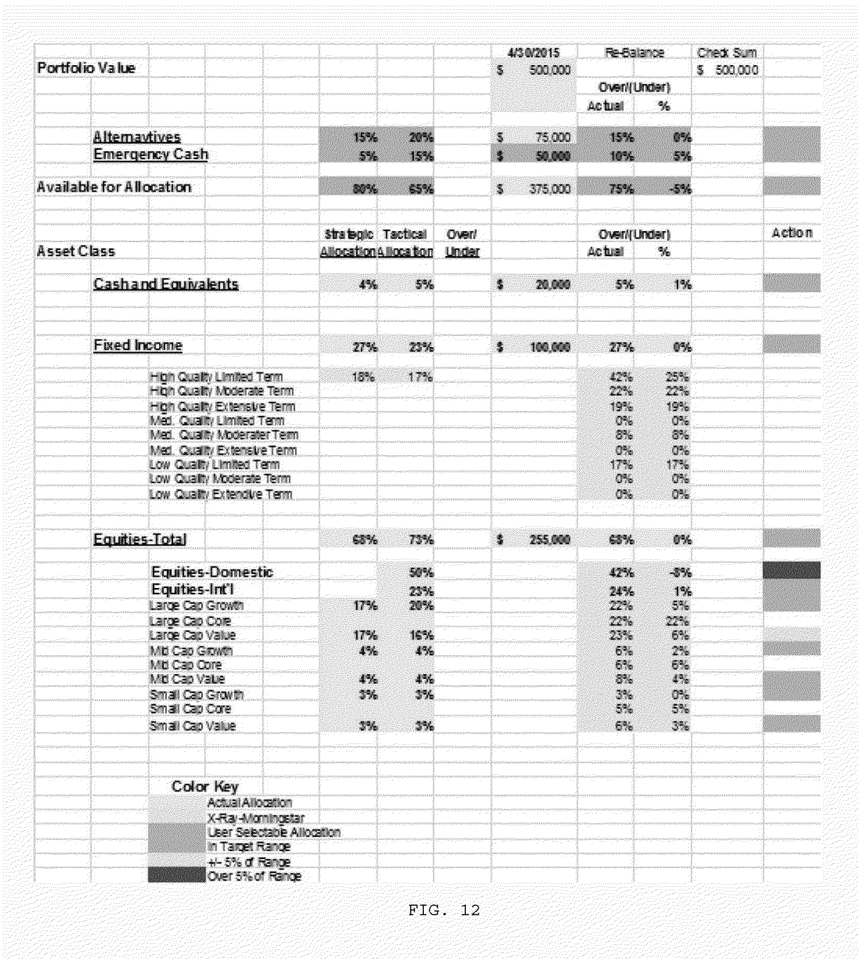

In addition to communicating, printing, displaying, or otherwise outputting a visual representation of the historical and ongoing performance of the investments in comparison to the rolling average and upper and lower control limits of the metric, and optionally providing alerts indicating a statistically-unusual event, in various example embodiments a computer processing structure may also generate periodic investment evaluation reports based on said information plus additional information input by or for the investor. Such other information input by or for the investor into the computer processing structure may include, for example and not by way of limitation, answers to assessment questions such as: the investor's investment objectives, such as goals or targets, the investor's risk tolerance, preferred baselines to measure against, and preferred asset allocation levels among different investment types. Based on the information input by or for the investor and the data output by the statistical analysis, in various example embodiments the computer processing structure may communicate, print, display, or otherwise output periodic investment evaluation reports providing one or more indications of investment performance, such as indicating whether the investor's investments are growing overall; whether the investor's predetermined investment objectives, goals, or targets, such as minimum and preferred growth rates (see FIGS. 3 and 4), are being met; whether the investor's investments are performing consistently with a predetermined metric such as an index or weighted blend of indexes selected by the investor as a baseline (see FIGS. 5 to 10); whether the metrics selected by the investor as a baseline are performing consistently with the investor's predetermined investment objectives, and whether switching to a different baseline, strategy, or advisor may be appropriate; and whether the investor's allocations are within predetermined preferred limits (see FIG. 12).

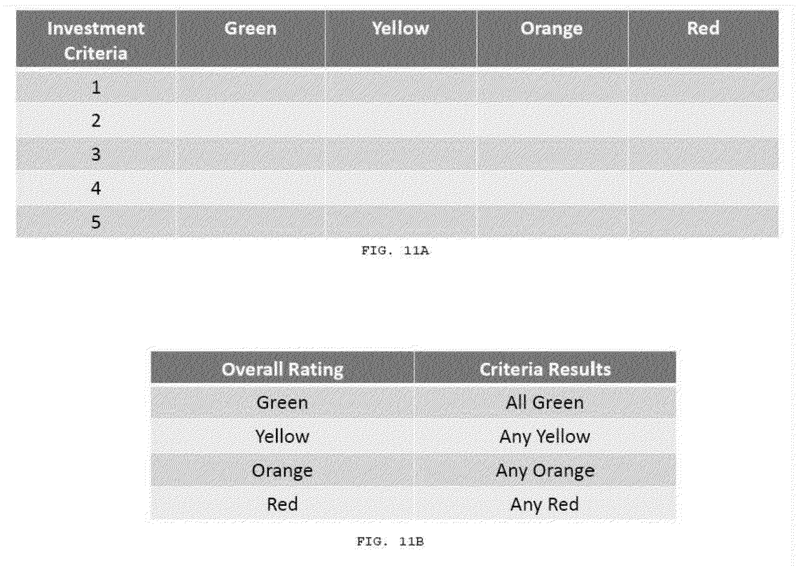

For example, FIG. 11A is an example matrix as communicated, printed, displayed, or otherwise outputted by a computer processing structure according to various example embodiments, for visually communicating the performance of various investment performance criteria, and FIG. 11B is an example color key for interpreting the example matrix of FIG. 11A. In various example embodiments, such a matrix and color-coded key can be communicated, printed, displayed, or otherwise outputted by the computer processing structure as part of a performance report. For example but not by way of limitation, the first criteria can be whether the investment has gained or lost value over a selected time period. The second criteria can be whether the investment met or fell below a goal or minimum expected annual return rate. The third criteria can be an evaluation of the investment's performance relative to one or more metrics, as discussed herein and shown in FIGS. 5-10 (e.g., were there any alerts, and how severe ere they). For instance, the performance of the investor's investments in comparison to the rolling average and upper and lower control limits of the metric may addressed by displaying colors in correspondence cells as follows, for example: Green: within control limits with no more than a 2 quarter negative trend; Yellow: negative three or more quarter trend but within control limits; Orange: Negative three or more quarter trend, below mean (or rolling average), but within control limits; and Red: any point below the lower control limit. With regard to questions relating to whether the investor's allocations are within preferred limits (e.g., as among cash, cash alternatives, equities, and fixed-income investments, as shown in FIG. 12), such a matrix may display colors as follows, for example: Green: in-range of strategic or tactical allocation; Yellow: within 5% of strategic allocation; Red: over 5% different from strategic allocation.

With continuing reference to FIGS. 11A and 11B, the fourth criteria can be an evaluation of the selected metric, e.g., whether it is appropriate for the investor's goals and investment style and temperament. The fifth criteria can be whether the investments in the portfolio have remained within their preferred proportional allocation levels. Whether or not these criteria have been met and to what degree can be indicated by color-coded matrix cells as output by the computer processing structure, for instance as indicated in FIGS. 11A and 11B.

Likewise, FIG. 12 is an example of an asset allocation report that may be communicated, printed, displayed, or otherwise outputted by a computer processing structure according to various example embodiments, for visually communicating the relative allocations of assets in a portfolio over time, and visually flagging where allocations have exceeded predetermined limits. The report in FIG. 12 also uses color coding in cells to indicate whether or not the allocation criteria have been met and to what degree.

Additionally, based on the information input by or for the investor, the periodic investment evaluation reports optionally generated by the computer processing structure may highlight points of interest, such as areas that are underperforming based on equivalent market conditions, and any tracking errors to the chosen index. Based on the computer processing structure's analysis of the data and prior entries, such example evaluation reports may provide recommended actions, such as, for example: increasing or decreasing allocation to cash for emergencies, increasing or decreasing allocation to alternative investments to increase alpha (a) (the performance of that investment compared to a suitable market index); increasing or decreasing the risk level of the investment; increasing deposits or reducing expenses such as withdrawals; and changing advisors. The reports may also generate and output a list of questions for the investor to consider asking their advisor, where the questions are generated based on the analysis of the data and information described herein, for example. For instance, questions might include: ask your advisor whether this metric is appropriate for your goals, or have your goals changed. Such reports empower the investor by providing data-driven statistical feedback on investment performance relative to any suitable metric, such as indexes or other investments such as managed funds, or weighted combinations thereof. Managed funds can also be compared or tracked relative to each other to evaluate the relative performance of the managers of the funds, all with the goal of improving investment performance.

FIG. 13 illustrates a schematic of an example computer processing structure that may implement the methodology of the present disclosure. The computer processing structure is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 13 may include, but are not limited to, personal computer processing structures, server computer processing structures, thin clients, thick clients, smart phones, tablets, handheld or laptop devices, multiprocessor systems, microprocessor-based systems, set top boxes, programmable consumer electronics, network PCs, minicomputer processing structures, mainframe computer processing structures, and distributed cloud computing environments that include any of the above systems or devices, and the like.

The computer processing structure may be described in the general context of a computer comprising executable instructions, such as program modules, being executed by a computer processing structure. Generally, program modules may include routines, programs, objects, components, logic, data structures, and so on that perform particular tasks or implement particular abstract data types. The computer processing structure may be practiced in distributed cloud computing environments where tasks are performed by remote processing devices that are linked through a communications network. In a distributed cloud computing environment, program modules may be located in both local and remote computer processing structure storage media including memory storage devices.

The components of computer processing structure may optionally include, but are not limited to, one or more processors or processing units 12, a system memory 16, and a bus 14 that couples various system components including system memory 16 to processor 12. The processor 12 may include one or more components of one or more data processing, calculating, formatting, and communicating modules 10 that perform the methods described herein. The modules 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer processing structure may include a variety of computer processing structure readable media. Such media may be any available media that is accessible by computer processing structure, and it may include both volatile and non-volatile media, removable and non-removable media.

System memory 16 can include computer processing structure readable media in the form of volatile memory, such as random access memory (RAM) and/or cache memory or others. Computer processing structure may further include other removable/non-removable, volatile/non-volatile computer processing structure storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer processing structure may also communicate with one or more external devices 26 such as a keyboard, a pointing device, a display 28, etc.; one or more devices that enable a user to interact with computer processing structure; and/or any devices (e.g., network card, modem, etc.) that enable computer processing structure to communicate with one or more other computing devices. Such communication can occur via Input/Output (I/O) interfaces 20.

Still yet, computer processing structure can communicate with one or more networks 24 such as a local area network (LAN), a general wide area network (WAN), and/or a public network (e.g., the Internet) via network adapter 22. As depicted, network adapter 22 communicates with the other components of computer processing structure via bus 14. It should be understood that although not shown, other hardware and/or software components could be used in conjunction with computer processing structure. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various example embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer processing structure—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer processing structure. The terms “computer processing structure” and “computer network” as may be used in the present application may include a variety of combinations of fixed and/or portable computer hardware, software, peripherals, and storage devices. The computer processing structure may include a plurality of individual components that are networked or otherwise linked to perform collaboratively, or may include one or more stand-alone components. The hardware and software components of the computer processing structure of the present application may include and may be included within fixed and portable devices such as desktop, laptop, and/or server. A module may be a component of a device, software, program, or system that implements some “functionality”, which can be embodied as software, hardware, firmware, electronic circuitry, or the like.

Any of the suitable technologies set forth and incorporated herein may be used to implement various example aspects of the invention as would be apparent to one of skill in the art.

Although exemplary embodiments and applications of the invention have been described herein including as described above and shown in the included example Figures, there is no intention that the invention be limited to these exemplary embodiments and applications or to the manner in which the exemplary embodiments and applications operate or are described herein. Indeed, many variations and modifications to the exemplary embodiments are possible as would be apparent to a person of ordinary skill in the art. The invention may include any device, structure, method, or functionality, as long as the resulting device, system or method falls within the scope of one of the claims that are allowed by the patent office based on this or any related patent application.

What is claimed is:

1. A method of analyzing the performance of an investment by utilizing computer processing structure, the method comprising the steps of:
determining with the computer processing structure a periodic series of percentage changes of a metric over a period of time;
determining with the computer processing structure a rolling average of the percentage changes of the metric over a period of time;
determining with the computer processing structure a rolling upper control limit that is greater in value than the rolling average of the metric by a multiple of a standard deviation of the periodic series of percentage changes of the metric over the period of time;
determining with the computer processing structure a rolling lower control limit that is lesser in value than the rolling average of the metric by a multiple of a standard deviation of the periodic series of percentage changes of the metric over the period of time;
determining with the computer processing structure a periodic series of percentage changes of an investment over the period of time; and
outputting from the computer processing structure a visual representation of the periodic series of percentage changes of the investment over the period of time, overlaid with a visual representation of the rolling average of the percentage changes of the metric over the period of time and a visual representation of the rolling upper control limit over the period of time and a visual representation of the rolling lower control limit over the period of time.

2. The method of claim 1, further comprising the steps of:
selecting with the computer processing structure the metric from a list of predetermined metrics.

3. The method of claim 1, further comprising the steps of:
generating with the computer processing structure the metric by entering a plurality of sub-metrics and allocating a percentage weight to each sub-metric.

4. The method of claim 1, further comprising the steps of:
determining with the computer processing structure whether the periodic series of percentage changes of the investment over the period of time exceeds the rolling upper control limit or the rolling lower control limit over the period of time.

5. The method of claim 4, further comprising the steps of:
generating with the computer processing structure and electronically communicating an alert when the periodic series of percentage changes of the investment over the period of time exceeds the rolling upper control limit or the rolling lower control limit over the period of time.

6. The method of claim 5, further comprising the steps of:
changing the investment or the metric with the computer processing structure based on information communicated in the alert.

7. The method of claim 1, further comprising the steps of:
determining with the computer processing structure whether the periodic series of percentage changes of the investment remains above or below the rolling average of the percentage changes of the metric for a predetermined period of time.

8. The method of claim 7, further comprising the steps of:
generating with the computer processing structure and electronically communicating an alert when the periodic series of percentage changes of the investment remains above or below the rolling average of the percentage changes of the metric for a predetermined period of time.

9. The method of claim 1, further comprising the steps of:
selecting with the computer processing structure a different investment based on the visual representation.

10. The method of claim 1, further comprising the steps of:
selecting with the computer processing structure a different metric based on the visual representation.

11. A computer processing structure for analyzing the performance of an investment, the computer processing structure comprising:
means for determining a periodic series of percentage changes of a metric over a period of time;
means for determining a rolling average of the percentage changes of the metric over a period of time;
means for determining a rolling upper control limit that is greater in value than the rolling average of the metric by a multiple of a standard deviation of the periodic series of percentage changes of the metric over the period of time;
means for determining a rolling lower control limit that is lesser in value than the rolling average of the metric by a multiple of a standard deviation of the periodic series of percentage changes of the metric over the period of time;
means for determining a periodic series of percentage changes of an investment over the period of time; and
means for outputting a visual representation of the periodic series of percentage changes of the investment over the period of time, overlaid with a visual representation of the rolling average of the percentage changes of the metric over the period of time and a visual representation of the rolling upper control limit over the period of time and a visual representation of the rolling lower control limit over the period of time.

12. The computer processing structure of claim 11, further comprising:
means for selecting the metric from a list of predetermined metrics.

13. The computer processing structure of claim 11, further comprising:
means for generating the metric by entering a plurality of sub-metrics and allocating a percentage weight to each sub-metric.

14. The computer processing structure of claim 11, further comprising:
means for determining whether the periodic series of percentage changes of the investment over the period of time exceeds the rolling upper control limit or the rolling lower control limit over the period of time.

15. The method of claim 14, further comprising:
means for generating and electronically communicating an alert when the periodic series of percentage changes of the investment over the period of time exceeds the rolling upper control limit or the rolling lower control limit over the period of time.

16. The method of claim 15, further comprising:
means for changing the investment or the metric based on information communicated in the alert.

17. The computer processing structure of claim 11, further comprising:
means for determining whether the periodic series of percentage changes of the investment remains above or below the rolling average of the percentage changes of the metric for a predetermined period of time.

18. The method of claim 17, further comprising:
means for generating and electronically communicating an alert when the periodic series of percentage changes of the investment remains above or below the rolling average of the percentage changes of the metric for a predetermined period of time.

19. The computer processing structure of claim 11, further comprising:
means for selecting a different investment based on the visual representation.

20. The computer processing structure of claim 11, further comprising:
means for selecting a different metric based on the visual representation.
